(19) United States
(12) Patent Application Publication
(10) Pub. No.: US 2008/0234085 A1
(43) Pub. Date: Sep. 25, 2008

(54) BELT, BELT GUIDE AND IMAGE FORMING APPARATUS HAVING THE SAME

(75) Inventor: Jean Man SUR, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/947,034

(22) Filed: Nov. 29, 2007

(30) Foreign Application Priority Data
Mar. 19, 2007 (KR) 2007-26769

(51) Int. Cl. F16H 7/24; F16H 7/18; F16G 1/22

(52) U.S. Cl. 474/150; 474/242; 474/140

(57) ABSTRACT

A belt guide and an image forming apparatus having the same are disclosed. The image forming apparatus includes a belt supported by supporting rollers and circulates endlessly. A belt guide is disposed on contact portions between the belt and each of the supporting rollers to prevent a separation of the belt from the supporting rollers. The belt guide is formed in a multi-step concave-convex shape, e.g., a staircase-like shape or a square wave shape. Accordingly, a contact area between the belt and the supporting roller is maximized, thereby effectively preventing wear, separation and color mis-registration of the belt due to meandering thereof.

### CROSS-REFERENCE TO RELATED APPLICATIONS

This application claims priority under 35 U.S.C. §119(a) from Korean Patent Application No. 2007-0026769, filed on Mar. 19, 2007 in the Korean Intellectual Property Office, the disclosure of which is incorporated herein in its entirety by reference.

### BACKGROUND OF THE INVENTION

1. Field of the Invention

The present general inventive concept relates to a belt, belt guide and an image forming apparatus having the same, and more particularly to an image forming apparatus to transfer a visible image developed on a photosensitive body onto a printing medium by using a transfer belt.

2. Description of the Related Art

An image forming apparatus is an apparatus that prints an image on a printing medium, e.g., paper, according to an input image signal. As one type of image forming apparatus, an electrophotographic color image forming apparatus is configured such that light is scanned to a photosensitive body charged with a predetermined electric potential to form an electrostatic latent image on an outer peripheral surface of the photosensitive body, the electrostatic latent image is developed into a visible image by supplying a developer (toner, or toner and carrier) to the electrostatic latent image, and the visible image is transferred onto and fixed to paper.

A conventional image forming apparatus includes a main body which forms an exterior appearance, a print unit which is mounted inside the main body, a paper supply unit which supplies paper to the print unit, and a paper discharge unit which discharges the printed paper to the outside of the main body. In the case of a color image forming apparatus, the print unit includes an exposure unit and a developing unit to form yellow, magenta, cyan and black visible images on the respective photosensitive bodies, a transfer unit which transfers the visible images formed on the photosensitive bodies onto the paper, and a fixing unit which applies heat and pressure to the paper to fix the visible images to the paper.

Japanese Patent Laid-Open Publication No. 2004-85702 discloses an image forming apparatus, in which an intermediate transfer belt is disposed opposite to four photosensitive bodies, visible images formed on the respective photosensitive bodies are first transferred onto the intermediate transfer belt by being sequentially overlapped, and the visible images are secondarily transferred onto paper passing between the intermediate transfer belt and a second transfer roller which is in close contact with the intermediate transfer belt, thereby obtaining a color image.

In the above conventional image forming apparatus, the intermediate transfer belt rotates while being supported by a plurality of rollers. However, when the shafts of the rollers are not disposed in parallel with each other, the intermediate transfer belt meanders by being biased to any one direction, and is even separated from the rollers. The meandering of the intermediate transfer belt causes color mis-registration, which refers to overlapping positional deviation of four colors, and as a result creates a deterioration of image quality.

To solve the above problem, the conventional image forming apparatus is provided with a guide that includes a protrusion and a recess, to prevent the intermediate transfer belt from being deviated from a specific position. However, a load due to friction is concentrated on contact portions between the protrusion and the recess, specifically, side surfaces of the rectangular shaped guide. Therefore, when used for a long period, the problems of meandering, separation and color mis-registration of the intermediate transfer belt occur similarly due to the wear of the guide.

### SUMMARY OF THE INVENTION

The present general inventive concept provides a belt guide and an image forming apparatus having the same to prevent meandering, separation and color mis-registration of a belt.

Additional aspects and/or advantages of the general inventive concept will be set forth in part in the description which follows and, in part, will be obvious from the description, or may be learned by practice of the general inventive concept.

The foregoing and/or other aspects and utilities of the general inventive concept may be achieved by providing an image forming apparatus including a belt supported by supporting rollers and circulates endlessly, the image forming apparatus including a concave-convex guide disposed on contact portions between the belt and each of the supporting rollers to prevent a separation of the transfer belt from the supporting rollers, wherein the concave-convex guide is formed in a multi-step shape.

The concave-convex guide may include a protruding portion disposed on an inner surface of the belt, and a concave portion disposed on an outer peripheral surface of each of the supporting rollers.

The protruding portion may have a first protruding portion and a second protruding portion which are stepped in a staircase-like shape, and the concave portion may have a first concave portion and a second concave portion formed corresponding to the first protruding portion and the second protruding portion.

The concave-convex guide may have slanted surfaces.

The concave-convex guide may be disposed on contact portions between the belt and each of the supporting rollers to prevent a separation of the belt from the supporting rollers, the concave-convex guide may include a protruding portion disposed on an inner surface of the belt, a depressed portion disposed on the protruding portion, a concave portion disposed on an outer peripheral surface of each of the supporting rollers correspondingly to the protruding portion, and a projecting portion disposed on the concave portion correspondingly to the depressed portion.

The concave-convex guide may have slanted surfaces.

The foregoing and/or other aspects and utilities of the general inventive concept may also be achieved by providing a belt guide usable with an image forming apparatus including a belt supported by supporting rollers and circulates endlessly, the belt guide including a belt guide portion disposed on contact portions between the belt and each of the supporting rollers to prevent a separation of the belt from the supporting rollers, wherein the belt guide portion is formed in a multi-step concave-convex shape.

The belt guide portion may be disposed on contact portions between the belt and each of the supporting rollers to prevent a separation of the belt from the supporting rollers, wherein the belt guide portion may be formed in a concave-convex shape, and including a protruding portion disposed on an inner surface of the belt, a depressed portion disposed on the protruding portion, a concave portion disposed on an outer peripheral surface of each of the supporting rollers correspondingly to the protruding portion, and a projecting portion disposed on the concave portion correspondingly to the depressed portion.

The foregoing and/or other aspects and utilities of the general inventive concept may also be achieved by providing a belt supporting unit to rotatably support a belt having a set of protruding portions of an image forming apparatus, the belt supporting unit including a first roller having a first set of recessed receiving portions and a second roller having a second set of recessed receiving portions, wherein one of the first set of recessed receiving portions and a corresponding one of the second set of recessed receiving portions conforms to and engages one of the set of protruding portions of the belt, and an other one of the first set of recessed receiving portions and a corresponding one of the second set of recessed receiving portions conforms to and engages an other of the set of protruding portions of the belt.

The foregoing and/or other aspects and utilities of the general inventive concept may also be achieved by providing a belt usable with an image forming apparatus having a belt supporting unit, the belt including a set of protruding portions opposite to each other and longitudinally arranged to engage recessed receiving portions of the belt supporting unit, wherein the protruding portions have a multistep convex-concave shape and conforms to the respective recessed receiving portions of the belt supporting unit.

The foregoing and/or other aspects and utilities of the general inventive concept may also be achieved by providing a transfer belt device usable with an image forming apparatus, the transfer belt including a continuous transfer belt having protruding portions at each end thereof and a pair of supporting rollers each having concave portions at opposite ends thereof to receive respective ones of the protruding portions to guide the transfer belt while rotating.

### BRIEF DESCRIPTION OF THE DRAWINGS

These and/or other aspects and utilities of the exemplary embodiments of the general inventive concept will become apparent and more readily appreciated from the following description of the embodiments, taken in conjunction with the accompanying drawings, of which:

FIG. 1 is a view illustrating a constitution of an image forming apparatus in accordance with an embodiment of the present general inventive concept;

FIG. 2 is a perspective view illustrating an intermediate transfer belt and supporting rollers of the image forming apparatus in accordance with an embodiment of the present general inventive concept;

FIG. 3 is a sectional view taken along line III-III in FIG. 2; and

FIG. 4 is a sectional view illustrating a modified coupling structure of a concave-convex guide disposed between an intermediate transfer belt and a supporting roller.

### DETAILED DESCRIPTION OF THE PREFERRED EMBODIMENTS

Reference will now be made in detail to exemplary embodiments of the present general inventive concept, examples of which are illustrated in the accompanying drawings, wherein like reference numerals refer to like elements throughout. The embodiments are described below to explain the present general inventive concept by referring to the figures.

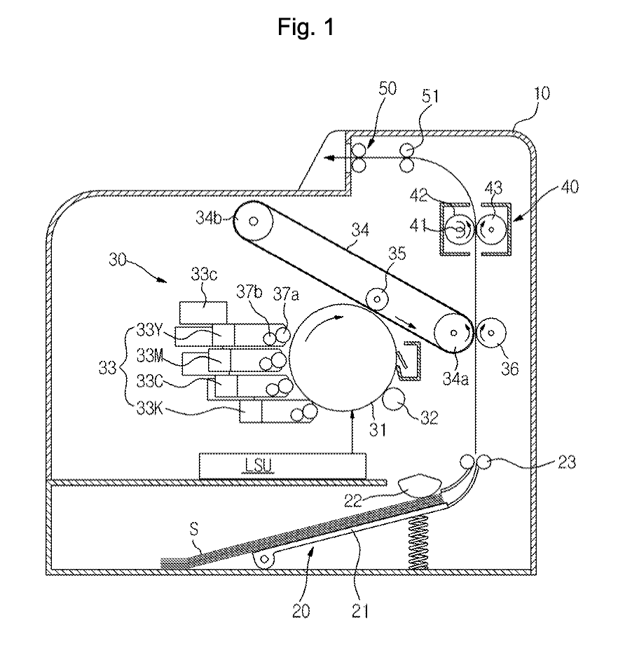

FIG. 1 is a schematic view illustrating a constitution of an image forming apparatus in accordance with an embodiment of the present general inventive concept.

Referring to FIG. 1, the image forming apparatus includes a main body 10 to form an exterior appearance and to support components accommodated therein, a printing medium supply unit 20 to supply a printing medium, i.e., paper S, a developing unit 30 to develop images on the paper, a fixing unit 40 to fix the images on the paper by applying heat and pressure to the paper, and a printing medium discharge unit 50 to discharge the printed paper to the outside of the main body 10.

The printing medium supply unit 20 includes a printing medium tray 21 on which the paper S is loaded, a pickup roller 22 to pick up the paper S loaded on the printing medium tray 21 sheet by sheet, and a feed roller 23 to feed the picked-up paper toward the developing unit 30.

The developing unit 30 includes a photosensitive body 31 on which an electrostatic latent image is formed by an exposure unit (laser scanning unit, LSU), a charge roller 32 to charge the photosensitive body 31, four developing devices 33Y, 33M, 33C and 33K (hereinafter, commonly denoted by 33) to develop the electrostatic latent image formed on the photosensitive body 31 into a visible image by using yellow, magenta, cyan and black toners, an intermediate transfer belt 34, a first transfer roller 35, and a second transfer roller 36.

Each of the developing devices 33 includes a developing roller 37a to develop the electrostatic latent image formed on the photosensitive body 31 by supplying a developer to the electrostatic latent image, and a supply roller 37b to rotate while contacting the developing roller 37a to supply the developer to the developing roller 37a. A developer supply device 33c is removably mounted on the developing devices 33.

The intermediate transfer belt 34 is supported by support rollers, i.e., a driving roller 34a and a tension roller 34b, and runs at a same velocity as a rotational linear velocity of the photosensitive body 31. The first transfer roller 35 is disposed opposite to the photosensitive body 31, and transfers the visible image developed on the photosensitive body 31 onto the intermediate transfer belt 34. The second transfer roller 36 is disposed opposite to the intermediate transfer belt 34. While the visible image is transferred onto the intermediate transfer belt 34 from the photosensitive body 31, the second transfer roller 36 is spaced apart from the intermediate transfer belt 34. When the visible image is completely transferred onto the intermediate transfer belt 34, the second transfer roller 36 comes into contact with the intermediate transfer belt 34 with a predetermined pressure.

The fixing unit 40 to fix the visible image to the paper by applying heat and pressure to the paper includes a heat roller 42 which has a heat source 41 to heat the toner-transferred paper, and a press roller 43 which is disposed opposite to the heat roller 42 and maintains a constant fixing pressure with the heat roller 42.

The printing medium discharge unit 50 includes discharge rollers 51 which are sequentially mounted so as to discharge the paper having passed through the fixing unit 40 to the outside of the main body 10.

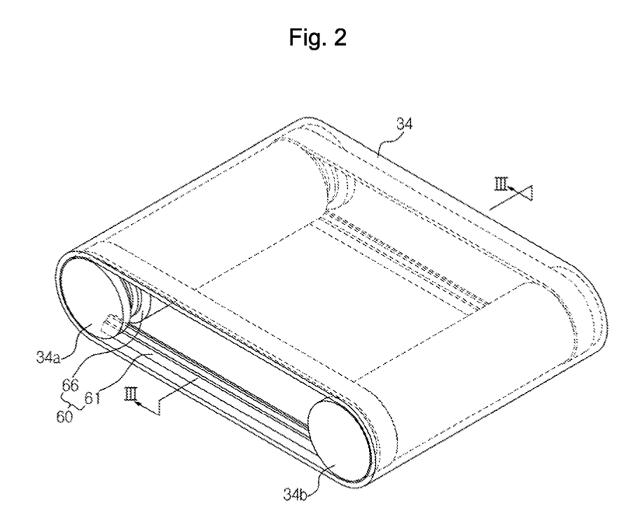

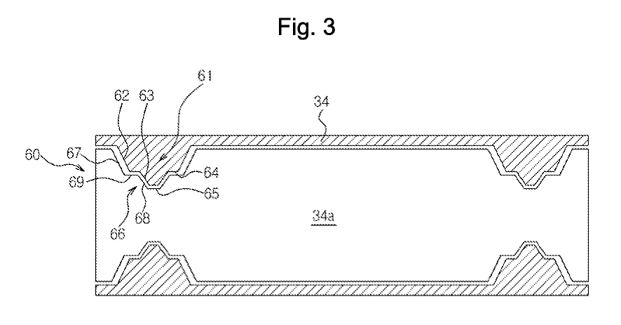

FIG. 2 is a perspective view illustrating the intermediate transfer belt and the supporting rollers of the image forming apparatus according to an embodiment of the present general inventive concept, and FIG. 3 is a sectional view taken along line III-III in FIG. 2. Although the present embodiment will be described with a transfer belt guide disposed between the intermediate transfer belt 34 and the driving roller 34a of the supporting rollers, the present general inventive concept is not restricted thereto. The present general inventive concept can also be applied to the tension roller 34b.

Referring to FIG. 2, a transfer belt guide such as a concave-convex guide 60 having a concave-convex shape is disposed between the intermediate transfer belt 34 and the supporting roller 34a, to prevent meandering and a separation of the intermediate transfer belt 34 with respect to the supporting rollers 34a and 34b. The concave-convex guide 60 includes a protruding portion 61 disposed on an inner surface of the intermediate transfer belt 34, and a concave portion 66 disposed on an outer peripheral surface of the supporting roller 34a.

In the present embodiment, the concave-convex guide 60 is formed in a multi-step staircase-like shape. As illustrated in FIG. 3, the protruding portion 61 includes a first protruding portion 62 and a second protruding portion 63, and the concave portion 66 includes a first concave portion 67 and a second concave portion 68. A first intermediate horizontal portion 64 is disposed between and connects the first protruding portion 62 and the second protruding portion 63. A second intermediate horizontal portion 69 is disposed between and connects the first concave portion 67 and the second concave portion 68 and corresponds to the first intermediate horizontal portion 64.

If the concave-convex guide 60 is formed in a multi-step shape, a contact area between the intermediate transfer belt 34 and the supporting roller 34a is maximized. Accordingly, a force exerted on the protruding portion 61 and the concave portion 66 is relatively dispersed, thereby decreasing the occurrence of wear on the transfer belt 34. Also, an increase in the contact area causes the increase in the contact force between the protruding portion 61 and the concave portion 66, thereby preventing the meandering or twisting of the intermediate transfer belt 34. As a result, the color mis-registration can be effectively prevented.

Furthermore, as illustrated in FIG. 3, forming the side walls of the first and second protruding portions 62 and 63, and the side walls of the first and second concave portions 67 and 68 as slanted surfaces, the contact area between the protruding portion 61 and the concave portion 66 can be increased. Accordingly, the wear and meandering of the intermediate transfer belt 34 can be more effectively prevented.

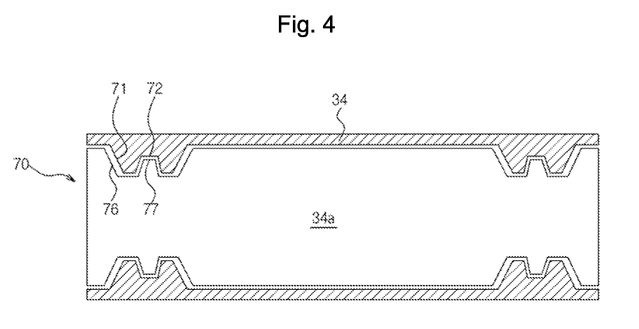

FIG. 4 is a sectional view illustrating a modified coupling structure of the concave-convex guide 60 disposed between the intermediate transfer belt 34 and the supporting roller 34a. Referring to FIG. 4, a concave-convex guide 70 disposed between the intermediate transfer belt 34 and the supporting roller 34a is modified to have a square wave shape, which will now be explained with an emphasis on a difference from the aforesaid concave-convex guide 60.

The concave-convex guide 70 disposed between the intermediate transfer belt 34 and the supporting roller 34a includes a protruding portion 71 disposed on an inner surface of the intermediate transfer belt 34, and a concave portion 76 disposed on an outer peripheral surface of the supporting roller 34a. The protruding portion 71 is formed with a depressed portion 72 which is depressed inwardly, and the concave portion 76 is formed with a projecting portion 77 corresponding to the depressed portion 72.

Similarly to the aforesaid concave-convex guide 60, the concave-convex guide 70 has features that a contact area between the intermediate transfer belt 34 and the supporting roller 34a is maximized. Accordingly, a force exerted on a unit area is dispersed, thereby decreasing wear. Also, an increase in the contact area reinforces the contact between the intermediate transfer belt 34 and the supporting roller 34a, thereby preventing meandering or twisting of the intermediate transfer belt 34. As a result, the color mis-registration can be effectively prevented.

Referring to FIG. 4, forming the side walls of the protruding portion 71 and the depressed portion 72, and the side walls of the concave portion 76 and the projecting portion 77 as slanted surfaces, the contact area can be more increased. Accordingly the wear and meandering of the intermediate transfer belt 34 can be more effectively prevented.

Although various embodiments have described that the concave-convex guide 60 or 70 is disposed on the intermediate transfer belt 34 to transfer the image formed on the photosensitive body 31 onto the second transfer roller, the present general inventive concept is not restricted thereto. The present general inventive concept can also be applied to an optical photo conductor (OPC) belt, a paper transfer belt or a developer feed belt through adequate modifications and changes.

As apparent from the above description, an image forming apparatus according to various embodiments of the present general inventive concept can maximize a contact area between a transfer belt and one or more supporting rollers and effectively prevent wear, separation and color mis-registration of the intermediate transfer belt by a transfer belt guide disposed on the contact portions between the intermediate transfer belt and the supporting roller. The image forming apparatus can also prevent meandering and separation of the intermediate transfer belt with respect to the one or more supporting rollers and has a multi-step staircase-like shape or a square wave shape.

Although various embodiments of the present general inventive concept have been illustrated and described, it would be appreciated by those skilled in the art that changes may be made in this embodiment without departing from the principles and spirit of the general inventive concept, the scope of which is defined in the claims and their equivalents.

What is claimed is:

1. An image forming apparatus including a belt which is supported by supporting rollers and circulates endlessly, the image forming apparatus comprising:
a concave-convex guide disposed on contact portions between the belt and each of the supporting rollers to prevent separation of the belt from the supporting rollers, wherein the concave-convex guide is formed in a multi-step shape.

2. The image forming apparatus according to claim 1, wherein the concave-convex guide comprises:
a protruding portion disposed on an inner surface of the belt; and
a concave portion disposed on an outer peripheral surface of each of the supporting rollers.

3. The image forming apparatus according to claim 2, wherein:
the protruding portion has a first protruding portion and a second protruding portion which are stepped in a staircase-like shape; and
the concave portion has a first concave portion and a second concave portion which are formed corresponding to the first protruding portion and the second protruding portion.

4. The image forming apparatus according to claim 3, wherein the concave-convex guide has slanted surfaces.

5. The image forming apparatus according to claim 1, wherein the belt comprises:
a transfer belt.

6. The image forming apparatus according to claim 1, wherein the concave-convex guide disposed on contact portions between the belt and each of the supporting rollers to prevent a separation of the belt from the supply rollers comprises:
a protruding portion disposed on an inner surface of the belt;
a depressed portion disposed on the protruding portion;
a concave portion disposed on an outer peripheral surface of each of the supporting rollers correspondingly to the protruding portion; and
a projecting portion disposed on the concave portion correspondingly to the depressed portion.

7. The image forming apparatus according to claim 6, wherein the concave-convex guide has slanted surfaces.

8. The image forming apparatus according to claim 6, wherein the belt comprises:
a transfer belt.

9. A belt guide usable with an image forming apparatus including a belt supported by supporting rollers and circulates endlessly, the belt guide comprising:
a belt guide portion disposed on contact portions between the belt and each of the supporting rollers to prevent a separation of the belt from the supporting rollers, wherein the belt guide portion is formed in a multi-step concave-convex shape.

10. The belt guide according to claim 9, wherein the belt guide portion having the concave-convex shape comprises:
a protruding portion disposed on an inner surface of the belt; and
a concave portion disposed on an outer peripheral surface of each of the supporting rollers.

11. The belt guide according to claim 10, wherein:
the protruding portion has a first protruding portion and a second protruding portion which are stepped in a staircase-like shape; and
the concave portion has a first concave portion and a second concave portion formed corresponding to the first protruding portion and the second protruding portion.

12. The belt guide according to claim 9, wherein the belt guide portion having the concave-convex shape has slanted surfaces.

13. The belt guide according to claim 9, wherein the belt comprises:
a transfer belt.

14. The belt guide according to claim 9, wherein the belt guide portion is disposed on contact portions between the belt and each of the supporting rollers to prevent a separation of the belt from the supporting rollers, the belt guide being formed in a concave-convex shape, and including a protruding portion disposed on an inner surface of the belt, a depressed portion disposed on the protruding portion, a concave portion disposed on an outer peripheral surface of each of the supporting rollers correspondingly to the protruding portion, and a projecting portion disposed on the concave portion correspondingly to the depressed portion.

15. The belt guide according to claim 14, wherein the belt guide portion having the concave-convex shape has slanted surfaces.

16. The belt guide according to claim 14, wherein the belt comprises:
a transfer belt.

17. A belt supporting unit to rotatably support a belt having a set of protruding portions of an image forming apparatus, the belt supporting unit comprising:
a first roller having a first set of recessed receiving portions; and
a second roller having a second set of recessed receiving portions,
wherein one of the first set of recessed receiving portions and a corresponding one of the second set of recessed receiving portions conforms to and engages one of the set of protruding portions of the belt, and an other one of the first set of recessed receiving portions and a corresponding one of the second set of recessed receiving portions conforms to and engages an other of the set of protruding portions of the belt.

18. The belt supporting unit according to claim 17, wherein a thickness of each of the protruding portions is substantially equal to a thickness of each of the recessed receiving portions.

19. The belt supporting unit according to claim 17, wherein an engagement of the protruding portions of the belt and the respective recessed receiving portions of the first and second rollers form a multi step concave-convex shape.

20. A belt usable with an image forming apparatus having a belt supporting unit, the belt comprising:
a set of protruding portions opposite to each other and longitudinally arranged to engage recessed receiving portions of the belt supporting unit,
wherein the protruding portions have a multi step convex-concave shape and conforms to the respective recessed receiving portions of the belt supporting unit.
